(19) United States
(12) Patent Application Publication
(10) Pub. No.: US 2004/0183376 A1
(43) Pub. Date: Sep. 23, 2004

(54) Vehicle theft deterrent system

(76) Inventor: Craig Tarbert, Deer Park, WA (US)

Correspondence Address: Raymond M. Galasso, Simon, Galasso & Frantz PLC, P.O. Box 26503, Austin, TX, 78755-0503, US

(21) Appl. No.: 10/804,444

(22) Filed: Mar. 19, 2004

Related U.S. Application Data
(60) Provisional application No. 60/456,274, filed on Mar. 20, 2003.

(51) Int. Cl. E05B 17/00

(52) U.S. Cl. 307/10.3; 340/426.11

(57) ABSTRACT

A vehicle theft deterrent system comprises a battery switch, an actuation device and a signal receiver. The battery switch is configured for enabling electrical continuity of a power cable connected between a battery and a starter of a vehicle starting system to be selectively broken and made. The battery switch is in a starting system disabled mode when the electrical continuity is broken and in a starting system enabled mode when the electrical continuity is made. The actuation device is connected to the battery switch and is configured for selectively switching the battery switch between the starting system disabled mode and the starting system enabled mode. The actuation device is connected to a switching mechanism of the battery switch and is configured for moving the switching mechanism between a first position corresponding to the starting system disabled mode and a second position corresponding to the starting system enabled mode.

### CROSS REFERENCE TO RELATED APPLICATIONS

This application claims priority to co-pending U.S. Provisional Patent Application having Serial No. 60/456,274 filed Mar. 20 2003 entitled “Auto Anti Theft Unit”, having a common applicant herewith.

### FIELD OF THE DISCLOSURE

The disclosures made herein relate generally to vehicle theft deterrent systems and, more particularly, to vehicle theft deterrent systems configured for selectively disabling a vehicle starting system.

### BACKGROUND

Conventional vehicle theft deterrent systems are often configured for selectively disabling a vehicle starting system by selectively breaking continuity in one or more appropriate starter switch wires/cables. Such conventional theft deterrent systems exhibit one or more shortcomings that limit their effectiveness. For example, one limitation is that such conventional theft deterrent systems are typically spliced into the starter switch wires under the dashboard, making access to such starter switch wires convenient for installation purposes. However, the under-dash location of such starter switch wires also makes such splices convenient to access by car thieves without drawing undesirable attention to themselves. Another limitation associated with such conventional systems is that they do not selectively break the continuity of the starting system power supply circuit (e.g., a cable) that is typically connected directly between the battery and the starter.

Therefore, a vehicle theft deterrent system that disables a vehicle starting system and that overcomes limitations associated with such conventional vehicle theft deterrent systems would be useful and novel.

### SUMMARY OF THE DISCLOSURE

Embodiments of the inventive disclosures made herein are comprised by vehicle theft deterrent systems that selectively disabling power supply to a starter of a vehicle starting system.

In one embodiment, a vehicle theft deterrent system comprises continuity circuitry and control circuitry. The continuity circuitry is configured for enabling electrical continuity between a battery and a starter of a vehicle starting system to be selectively broken and made. The control circuitry is connected to the continuity circuitry and is configured for enabling the continuity circuit to be selectively set to the starting system disabled mode and the starting system enabled mode. The continuity circuitry is in a starting system disabled mode when the electrical continuity is broken and in a starting system enabled mode when the electrical continuity is made.

In another embodiment, a vehicle theft deterrent system comprises a battery switch, an actuation device and a signal receiver. The battery switch is configured for enabling electrical continuity of a power cable connected between a battery and a starter of a vehicle starting system to be selectively broken and made. The battery switch is in a starting system disabled mode when the electrical continuity is broken and in a starting system enabled mode when the electrical continuity is made. The actuation device is connected to the battery switch and is configured for selectively switching the battery switch between the starting system disabled mode and the starting system enabled mode. The battery switch is configured for being spliced into the power cable in an in-line fashion. The actuation device is connected to a switching mechanism of the battery switch and is configured for moving the switching mechanism between a first position and a second position. The first position corresponds to the starting system disabled mode and the second position corresponds to the starting system enabled mode. The signal receiver is coupled to the actuation device. The signal receiver facilitates setting the actuation device to the first position in response to receiving a first control signal and setting the actuation device to the second position in response to receiving a second control signal.

Accordingly, it is a principal object of the inventive disclosures made herein to provide methods and equipment that significantly increase the effort to accomplish unauthorized starting of a vehicle.

It is another object of the inventive disclosures made herein to provide a vehicle theft deterrent system that is connected between the starter and the battery of a vehicle starting system.

It is another object of the inventive disclosures made herein to provide a vehicle theft deterrent system that selectively breaks continuity in a starting system power supply circuit.

It is another object of the inventive disclosures made herein is to provide a vehicle theft deterrent system that utilizes an electromagnetic switch or servo for selectively breaking continuity in a starting system power supply circuit.

It is another object of the inventive disclosures made herein to provide a vehicle theft deterrent system having components within a tamper-resistant enclosure.

It is another object of the inventive disclosures made herein to provide a vehicle theft deterrent system is activated and deactivated using a wireless control apparatus.

These and other objects of the inventive disclosures made herein will become readily apparent upon further review of the following specification and associated drawings.

### BRIEF DESCRIPTION OF THE DRAWINGS

FIG. 1 depicts a vehicle starting system in accordance with an embodiment of the inventive disclosures made herein.

FIG. 2 depicts a theft deterrent system in accordance with an embodiment of the inventive disclosures made herein

### DETAILED DESCRIPTION OF THE DRAWINGS

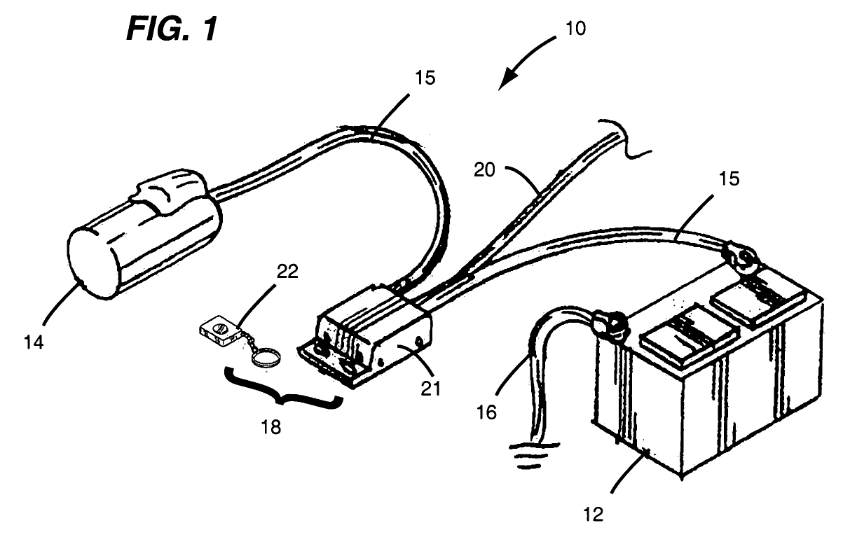

FIG. 1 depicts a vehicle starting system 10 in accordance with an embodiment of the inventive disclosures made herein. The vehicle starting system 10 includes a battery 12, a starter, 14 a power cable 15, a ground cable 16, a theft deterrent system 18 and an accessory item power cable 20. The theft deterrent system 18 includes a theft deterrent unit 21 and a signal transmitter 22. The theft deterrent unit 21 is spliced into the power cable 15 in an in-line fashion and is configured for enabling electrical continuity between the battery 12 and the starter 14 to be selectively broken and made.

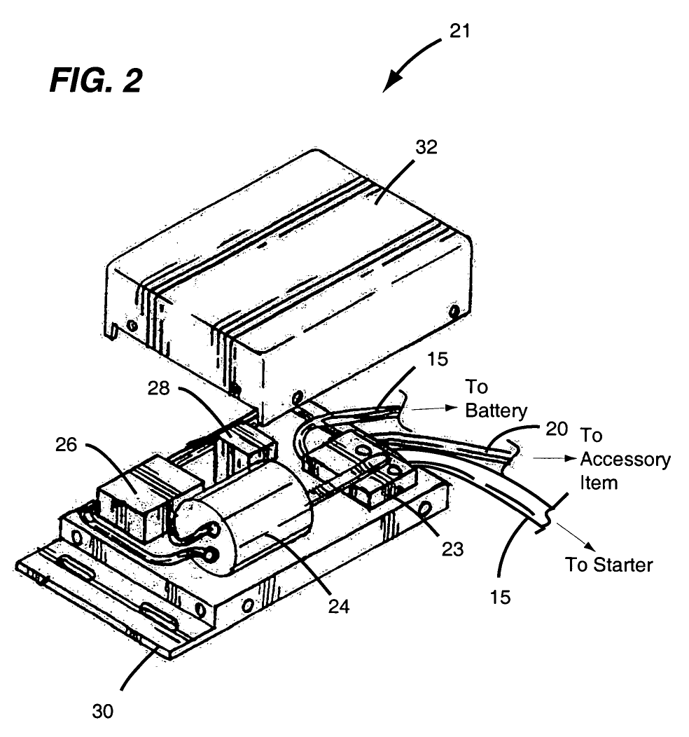

Referring now to FIGS. 1 and 2, the theft deterrent unit 21 includes a battery switch 23, an actuation device 24, a signal receiver 26, a relay switch 28, an enclosure base 30 and an enclosure cover 32. The battery switch 23 is electrically coupled between the battery 12 and the starter 14. The battery switch 23 is configured for selectively breaking and making electrical continuity of the power cable 15 between the battery 12 and the starter 14. The battery switch and, thus, the theft deterrent unit 10 are in a starting system disabled mode when the electrical continuity is broken and in a starting system enabled mode when the electrical continuity is made. In one embodiment, the tamper-resistant enclosure (e.g., made of steel) comprises the enclosure base 30 and the enclosure cover 32 and has access portals extending therethrough.

The actuation device 24 (e.g., an electromagnetic solenoid, an electromechanical servo, etc) is connected to the battery switch 23 and is configured for selectively switching the battery switch between the starting system disabled mode and the starting system enabled mode. In one embodiment, the actuation device 24 is connected to a switching mechanism (not specifically shown) of the battery switch 23 and is configured for moving the switching mechanism between a first position and a second position (e.g., physical positions, logical positions, etc). The first position of the switching mechanism corresponds to the starting system disabled mode and the second position of the switching mechanism corresponds to the starting system enabled mode.

The signal receiver 26 is coupled to the actuation device 24 through the relay switch 28 (e.g., a power relay). The signal receiver 26 facilitates setting the actuation device 24 to a first position corresponding to the starting system disabled mode in response to receiving a first control signal and setting the actuation device to a second position corresponding to the starting system enabled mode in response to receiving a second control signal. The signal transmitter 34 is configured for transmitting the first control signal and the second control signal for reception by the signal receiver 26. In one embodiment, such as depicted in FIGS. 1 and 2, the signal transmitter 34 is a wireless signal transmitter and the signal receiver 26 is correspondingly a wireless signal receiver, which are jointly configured for sending and receiving wireless signals (e.g., radio frequency signals). In another embodiment, not specifically shown, the signal receiver 26 and the signal transmitter 34 are replaced by a control switch that is electrically coupled (e.g., via one or more wires) to the relay switch 28.

In one embodiment, the battery switch 23 includes a plurality of electrical terminations. Cables ends, screw-down terminal, junction block contacts, electrical connector contacts and the like are examples of such electrical terminations. A first one of such electrical terminations is configured for being connected to a first connection point of the power cable 15. A second one of such electrical terminations is configured for being connected to at least one of a second connection point of the power cable 15, an electrical terminal of the battery 12 and an electrical terminal of the starter 14. A third one of such electrical terminations is coupled to either the first one of such electrical terminations or the second one of such electrical terminations for the purpose of having a power lead of a vehicle accessory item connected thereto for enabling electrical power to be provided to the accessory item while the battery switch 23 is in the starting system disabled mode.

Turning more to a brief discussion of circuitry in accordance with embodiments of the inventive disclosures made herein, continuity circuitry is configured for enabling electrical continuity between a battery and a starter of a vehicle starting system to be selectively broken and made. Such continuity circuitry is in a starting system disabled mode when the electrical continuity is broken and in a starting system enabled mode when the electrical continuity is made. Control circuitry is connected to the continuity circuitry and is configured for enabling the continuity circuit to be selectively set to the starting system disabled mode and the starting system enabled mode. In one embodiment, the continuity circuitry includes a battery switch and the control circuitry includes an actuation device, a signal receiver and a relay switch. The battery switch is electrically coupled to the actuation device, the signal receiver and the relay switch, thus coupling the continuity circuitry to the control circuitry.

In summary, embodiments of vehicle theft deterrent systems in accordance with the inventive disclosures made herein are designed to provide a high level of security against theft for owners of vehicles (e.g., cars, trucks SUV's, etc). Such theft deterrent systems operate in a manner unique from other anti-theft products. With such a theft deterrent system attached to a vehicle and in the active mode, a thief will not be able to crank the vehicle's engine, thus making it difficult to steal the vehicle.

Such theft deterrent systems comprise known and/or commercially available components (e.g., electronic components, electrical components, and hardware components, etc) that are interconnected to provide an easily installed and relatively simple operate theft deterrent system. The components of such theft deterrent systems include a remote transmitter unit, receiver unit, relay switch, solenoid, battery switch, and tamper-resistant enclosure. The receiver unit, relay switch, solenoid, battery switch, and enclosure are comprised by a control unit, which is typically mounted in the engine compartment of the vehicle, under the vehicle or in the truck area of the vehicle. In one embodiment, the tamper resistant enclosure includes a base and cover made from steel with wire/termination portals, thereby providing protection to the components of the theft deterrent system from incidental damage and the effects of natural/environmental conditions.

Theft deterrent systems in accordance with embodiments of the disclosures made herein are connected between the battery and the starter of the vehicle. In one embodiment, a power supply cable connected between the battery and the starter is severed. Then, a first severed end of the power supply cable is connected to a first batter switch termination of the theft deterrent system and a second severed end of the power supply cable is connected to a second battery switch termination of the theft deterrent system. In this manner, the theft deterrent system is configured for selectively disabling the vehicle's starter.

The theft deterrent system comprises actuation circuitry configured for selectively breaking and making continuity in the power supply cable connected between the starter and the battery of the vehicle. The actuation circuitry including an electronic signal receiver unit, solenoid, relay switch, battery switch and suitable terminations for making connections to the battery switch. In one embodiment, the battery switch is an electromagnetic switch or serve that enables continuity to be selectively made and broken.

In one embodiment, a remote control transmitter unit (e.g., small enough to carry on a key chain) is provided for activating and deactivating the theft deterrent system. The transmitter includes an electronic components configured for sending signals capability and interpretable by the receiver unit. Activation of the transmitter unit sends a signal to the receiver unit. This activates the solenoid through the relay switch that turns the battery switch. At this point, the starter will be disconnected from the battery, making it virtually impossible to start the vehicle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle theft deterrent system, comprising:
continuity circuitry configured for enabling electrical continuity between a battery and a starter of a vehicle starting system to be selectively broken and made, whereby said continuity circuitry is in a starting system disabled mode when said electrical continuity is broken and in a starting system enabled mode when said electrical continuity is made; and
control circuitry connected to said continuity circuitry and configured for enabling said continuity circuit to be selectively set to the starting system disabled mode and the starting system enabled mode.

2. The system of claim 1 wherein:
said continuity circuitry includes a battery switch configured for being electrically spliced into a power cable connected between the battery and the starter; and
the battery switch enables said electrical continuity to be selectively made and broken.

3. The system of claim 2 wherein the battery switch is configured for being spliced into the power cable in an in-line fashion.

4. The system of claim 2 wherein the battery switch includes:
a first electrical termination configured for being connected to a first connection point of the power cable; and
a second electrical termination configured for being connected to at least one of a second connection point of the power cable, an electrical terminal of the battery and an electrical terminal of the starter.

5. The system of claim 4 wherein the battery switch further includes:
a third electrical termination coupled to one of the first electrical termination and the second electrical termination for having a power lead of a vehicle accessory item connected thereto for enabling electrical power to be provided to the accessory item while said continuity circuitry is in the starting system disabled mode.

6. The system of claim 1 wherein:
said control circuitry includes an actuation device configured for facilitating switching of said continuity circuitry between the starting system disabled mode and starting system enabled mode.

7. The system of claim 6 wherein:
said continuity circuitry includes a battery switch configured for being electrically spliced into a power cable connected between the battery and the starter;
the actuation device is connected to a switching mechanism of the battery switch and is configured for moving the switching mechanism between a first position and a second position;
the first position corresponds to the starting system disabled mode; and
the second position corresponds to the starting system enabled mode.

8. The system of claim 7 wherein the actuation device includes one of a solenoid and servo connected to the switching mechanism of the battery switch.

9. The system of claim 1 wherein:
said control circuitry includes a signal receiver coupled to said continuity circuit;
the signal receiver facilitates setting said continuity circuitry to the starting system disabled mode in response to receiving a first control signal; and
the signal receiver facilitates setting said continuity circuitry to the starting system enabled mode in response to receiving a second control signal.

10. The system of claim 9, further comprising:
a signal transmitter configured for transmitting the first control signal and the second control signal for reception by the signal receiver.

11. The system of claim 9 wherein:
said control circuitry includes an actuation device configured for facilitating switching of said continuity circuitry between the starting system disabled mode and starting system enabled mode;
said continuity circuitry includes a battery switch configured for being electrically spliced into a power cable connected between the battery and the starter;
the actuation device is connected to a switching mechanism of the battery switch and is configured for moving the switching mechanism between a first position and a second position;
the first position corresponds to the starting system disabled mode; and
the second position corresponds to the starting system enabled mode.

12. A vehicle theft deterrent system, comprising:
a battery switch configured for enabling electrical continuity of a power cable connected between a battery and a starter of a vehicle starting system to be selectively broken and made, whereby the battery switch is in a starting system disabled mode when said electrical continuity is broken and in a starting system enabled mode when said electrical continuity is made; and
an actuation device connected to the battery switch and configured for selectively switching the battery switch between the starting system disabled mode and the starting system enabled mode.

13. The system of claim 12 wherein the battery switch is configured for being spliced into the power cable in an in-line fashion.

14. The system of claim 13 wherein:
the actuation device is connected to a switching mechanism of the battery switch and is configured for moving the switching mechanism between a first position and a second position;
the first position corresponds to the starting system disabled mode; and
the second position corresponds to the starting system enabled mode.

15. The system of claim 14, further comprising:
a signal receiver coupled to the actuation device, wherein the signal receiver facilitates setting the actuation device to the first position in response to receiving a first control signal and setting the actuation device to the second position in response to receiving a second control signal.

16. The system of claim 15, further comprising:
a signal transmitter configured for transmitting the first control signal and the second control signal for reception by the signal receiver.

17. The system of claim 16 wherein the battery switch includes:
a first electrical termination configured for being connected to a first connection point of the power cable;
a second electrical termination configured for being connected to at least one of a second connection point of the power cable, an electrical terminal of the battery and an electrical terminal of the starter; and
a third electrical termination coupled to one of the first electrical termination and the second electrical termination for having a power lead of a vehicle accessory item connected thereto for enabling electrical power to be provided to the accessory item while said continuity circuitry is in the starting system disabled mode.

18. A vehicle starting system, comprising:
a battery;
a starter;
a battery switch electrically coupled between the battery and the starter, wherein the battery switch is configured for enabling electrical continuity between the battery and the starter to be selectively broken and made and wherein the battery switch is in a starting system disabled mode when said electrical continuity is broken and in a starting system enabled mode when said electrical continuity is made;
an actuation device connected to the battery switch and configured for selectively switching the battery switch between the starting system disabled mode and the starting system enabled mode; and
a signal receiver coupled to the actuation device, wherein the signal receiver facilitates setting the actuation device to a first position corresponding to the starting system disabled mode in response to receiving a first control signal and setting the actuation device to a second position corresponding to the starting system enabled mode in response to receiving a second control signal.

19. The system of claim 18 wherein:
said electrical continuity between the battery and the starter is provided through a power cable; and
the battery switch is electrically spliced into the power cable in an in-line fashion.

20. The system of claim 18 wherein:
the actuation device is connected to a switching mechanism of the battery switch and is configured for moving the switching mechanism between a first position and a second position;
the first position of the switching mechanism corresponds to the starting system disabled mode; and
the second position of the switching mechanism corresponds to the starting system enabled mode.
